(19) United States
(12) Patent Application Publication
(10) Pub. No.: US 2013/0179714 A1
(43) Pub. Date: Jul. 11, 2013

(54) BACKUP POWER SUPPLY CIRCUIT AND METHOD

(71) Applicant: MING YU, Shenzhen City (CN)

(72) Inventor: MING YU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/591,316

(22) Filed: Aug. 22, 2012

(30) Foreign Application Priority Data
Jan. 9, 2012 (CN) 201210004367.1

(51) Int. Cl. G06F 1/30; G06F 1/32

(52) U.S. Cl. 713/323

(57) ABSTRACT

A backup power supply circuit includes a backup power supply unit, a delay unit, and a power supply chip. The backup power supply unit is connected to a computer system. The backup power supply unit supplies power to the computer system when a cutoff of an external power source of the computer system occurs. The power supply chip sets the computer system into an idle state when the cutoff of the external power of the computer system occurs. The delay unit sets a delay time. The delay unit countdowns the delay time at a beginning of the cutoff of the external power of the computer system, and controls the power supply chip to revive the computer system when the countdown is completed.

### BACKGROUND

1. Technical Field

The present disclosure relates to power supply circuits and methods, and more particularly to a backup power supply circuit and method.

2. Description of Related Art

Power management is adopted in computers to conserve energy while the computer is in use and put the computer to sleep to save energy when the computer is not in use. According to system power states derived from the Advanced Configuration and Power Interface (ACPI) specification, states of the computer are defined as follows: S0/Working—The CPU is fully up and running; devices are powering up and down as needed; S1—the CPU is stopped; RAM is refreshed; the system is running in a low power mode; S2—the CPU has no power; RAM is refreshed; the system is in a lower power mode than S1; S3—the CPU has no power; RAM is in slow refresh; the power supply is generally in a reduced power mode (for example, it can't supply much power and is running in a lower power efficiency mode); S4—the hardware is completely off; system memory has been saved to disk; S5/Off−the hardware is completely off; the operating system has shut down; nothing has been saved.

To avoid losing data, the computer is often equipped with a backup power supply unit. When an external power supply of the computer is cut off, the backup power supply unit takes over to provide power to the computer. However, data can be lost before the backup power supply starts to provide stable power to the computer.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a backup power supply circuit.

FIG. 2 illustrates a flowchart of a backup power supply method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

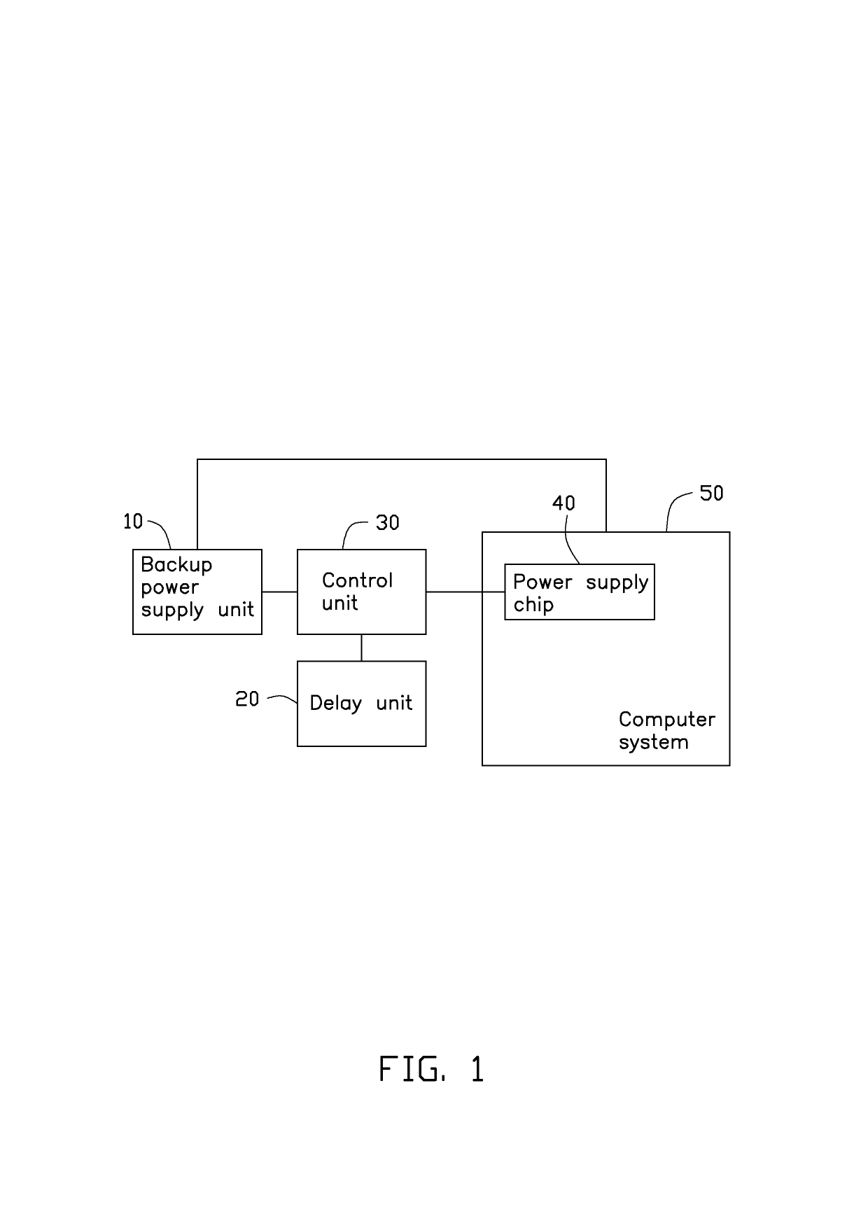

Referring to FIG. 1, an embodiment of a backup power supply circuit is shown. The backup power supply circuit includes a backup power supply unit 10, a delay unit 20, a control unit 30, and a power supply unit 40. In one embodiment, the power supply unit 40 is in a computer system 50.

The backup power supply unit 10 is connected to the computer system 50. The backup power supply unit 10 is configured to supply power to the computer system 50 when an external power source of the computer system is cut off. The backup power supply unit 10 is also connected to the control unit 30. The delay unit 20 is connected to the control unit 30. The power supply chip 40 is connected to the control unit 30.

At the moment of cutoff of the external power supply, the power supply chip 40 sends a backup running signal to the control unit 30, and simultaneously converts the computer system 50 into an idle state, such as into a standby state (S3 mode above) or a shut off state (S5 mode above). The control unit 30 controls the backup power supply unit 10 to provide power to the computer system 50 and triggers the delay unit 20 to begin delay. The delay unit 20 defines a delay time. When the delay time has passed, the control unit 30 sends a revive signal or a start up signal to the power supply chip 40. The power supply chip 40 then converts the computer system 50 in a running state (S1 mode above).

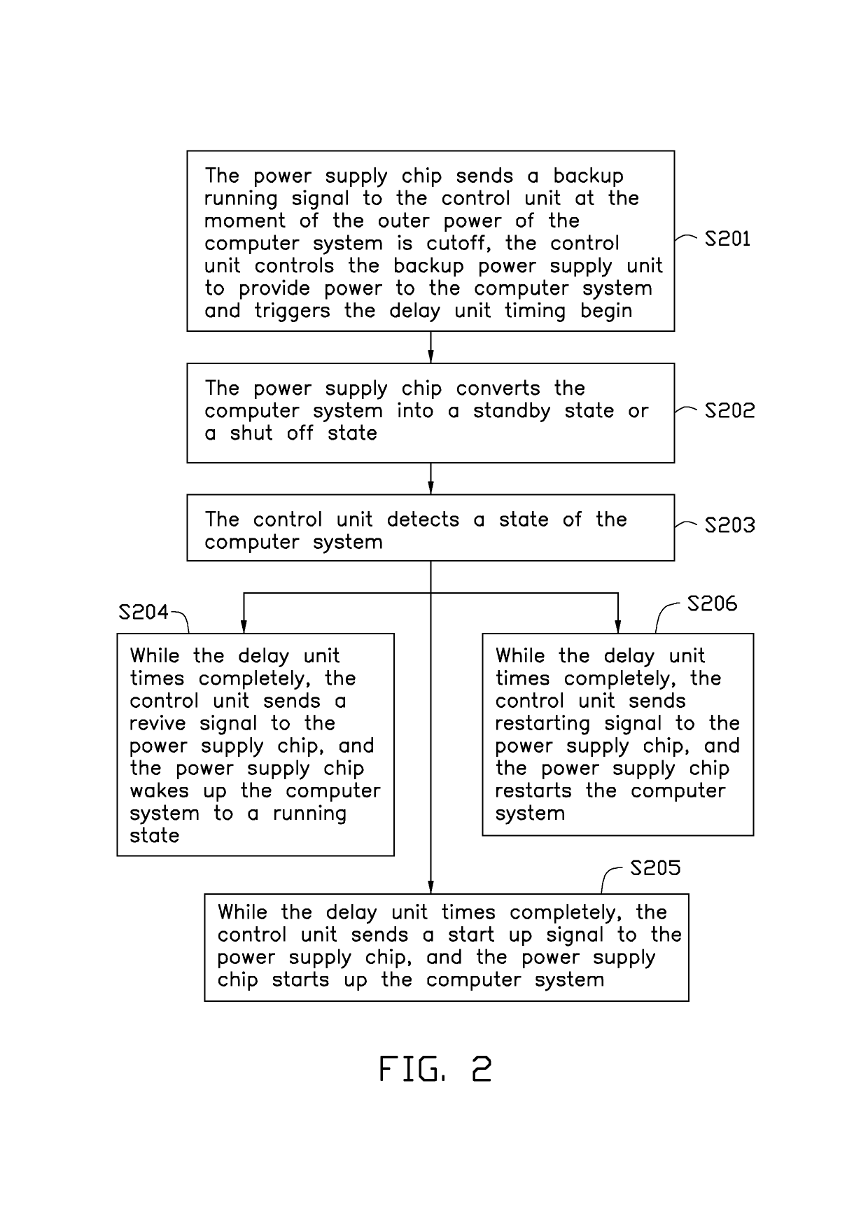

FIG. 2 shows an embodiment of a flow chart of a backup power supply method. The backup power supply method includes the following steps:

In step 201, the power supply chip 40 sends a backup running signal to the control unit 30 at the moment of cutoff of an external power supply, the control unit 30 controls the backup power supply unit 10 to provide power to the computer system 50 and triggers the delay unit 20 to begin delay.

In step 202, the power supply chip 40 converts the computer system 50 into a standby state (S3 mode above) or a shut off state (S5 mode above).

In step 203, the control unit 30 detects a state of the computer system 50; if the computer system 50 is in a standby state, go to step S204; if the computer system is in a shut off state, go to step S205, and if the computer system is not in the standby state or in the shut off state, go to step S206.

In step 204, while the delay unit 20 times completely, the control unit 30 sends a revive signal to the power supply chip 40, and the power supply chip 40 wakes up the computer system 50 into a running state.

In step 205, while the delay time of delay unit 20 has passed, the control unit 30 sends a start up signal to the power supply chip 40, and the power supply chip 40 starts up the computer system 50.

In step 206, while the delay time of delay unit 20 has passed, the control unit 30 sends restarting signal to the power supply chip 40, and the power supply chip 40 restarts the computer system 50.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A backup power supply circuit, comprising:
a backup power supply unit connected to a computer system, the backup power supply unit configured to supply power to the computer system when a cutoff of an external power of the computer system occurs;
a power supply chip configured to set the computer system into an idle state when the cutoff of the external power of the computer system occurs; and
a delay unit connected to the backup power supply unit and the power supply chip, the delay unit setting a delay time, the delay unit configured to countdown the delay time at a beginning of the cutoff of the external power of the computer system, and the delay unit further configured to control the power supply chip to revive the computer system when the countdown is completed.

2. The backup power supply circuit of claim 1, wherein a control unit is connected to the backup power supply unit, the delay unit, and the power supply chip; the power supply chip is configured to send a backup running signal to the control unit, and the control unit is configured to control the backup power supply unit to provide power to the computer system according to the backup running signal.

3. The backup power supply circuit of claim 2, wherein the control unit is configured to trigger the delay unit to begin to countdown the delay time according to the backup running signal.

4. The backup power supply circuit of claim 2, wherein the idle state comprises a standby state and a shut off state, the control unit is configured to detect a state of the computer system, to wake up the computer system when the countdown is completed and the computer system is in the standby state, and to start up the computer system when the countdown is completed and the computer system is in the shut off state.

5. The backup power supply circuit of claim 1, wherein the power supply chip is located in the computer system.

6. A backup power supply method, comprising:
sending a backup running signal to a control unit by a power supply chip when a cutoff of an external power of a computer system occurs;
setting the computer system into a standby state by the power supply chip when the cutoff of the external power of a computer system occurs;
controlling a backup power supply unit to provide power to the computer system and to trigger a delay unit to begin countdown to a delay time according to the backup running signal after the backup running signal is received by the control unit; and
reviving the computer system by the power supply chip after the countdown to the delay time is completed.

7. The backup power supply method of claim 6, wherein the idle state comprises a standby state and a shut off state; the backup power supply method further comprises detecting a state of the computer system by the control unit.

8. The backup power supply method of claim 7, further comprising waking up the computer system when the computer system is in the standby state by the control unit after the countdown to the delay time is completed.

9. The backup power supply method of claim 7, further comprising starting up the computer system when the computer system is in the shut off state by the control unit after the countdown to the delay time is completed.

10. The backup power supply method of claim 7, further comprising restarting the computer system when the computer system is not in the standby state or the shut off state by the control unit after the countdown to the delay time is completed.

11. The backup power supply method of claim 6, wherein the power supply chip is located in the computer system.
